(19) United States
(12) Patent Application Publication
(10) Pub. No.: US 2010/0117863 A1
(43) Pub. Date: May 13, 2010

(54) PARKING SYSTEM AND METHODS OF USE AND DOING BUSINESS

(76) Inventor: Kane Dutt, Reno, NV (US)

Correspondence Address: HOLLAND & HART, LLP, P.O BOX 8749, DENVER, CO, 80201, US

(21) Appl. No.: 12/615,997

(22) Filed: Nov. 10, 2009

Related U.S. Application Data
(60) Provisional application No. 61/113,040, filed on Nov. 10, 2008.

(51) Int. Cl. B60Q 1/48

(52) U.S. Cl. 340/932.2; 340/932.2

(57) ABSTRACT

A system and related methods of managing parking including arranging payment for parking. The systems and methods may provide communication of information to those using parking as well as others. The system may be configured to provide rental of vehicles, such as bicycles for example, in addition to providing parking and/or storage of such rented vehicles.

### CROSS-REFERENCE TO RELATED APPLICATION

This application claims that benefit of the filing date of U.S. Provisional Application No. 61/113,040, filed 10 Nov. 2008, and entitled PARKING SYSTEM AND METHODS, the disclosure of which is incorporated in its entirety by this reference.

### TECHNICAL FIELD

The present disclosure is directed to systems and methods for parking vehicles, such as automobiles, motorcycles, and bicycles, collecting payment for such parking, and communicating information to users of the system.

### BACKGROUND

Providing adequate parking for vehicles such as automobiles, motorcycles, bicycles and other transportation devices, particularly in downtown areas of metropolitan cities may be problematic due to limited space. Further, the collection of payment for use of parking spaces, particularly parking spaces that provide adequate safety and protection for the parked vehicle, may also be difficult. Often, significant human oversight is required in the form of parking lot attendants, security personnel, and surveillance equipment, which may be needed in order to provide desired levels of safety and security.

Bicycle theft and other types of vehicle theft have long presented very significant and widely recognized problems. These problems arise when the vehicle is parked and not in use and also when the vehicle is in storage or when being transported from one place to another.

Locking apparatuses used for bicycles include padlocks, chains, wirelocks, and u-locks. These types of locking apparatuses are typically portable and secure a portion of a cycle, such as a wheel or the frame, to another object such as a tree, bikerack, fence, etc. Other types of locking apparatuses are available for use with automobiles, motorcycles, and other vehicles.

While these types of security devices may be effective in preventing theft, they may sometimes be particularly unreliable or difficult to use. For example, when the transportation device is stored in a garage, the user often has difficulty finding an effective object to which the transportation device may be securely locked. In addition, substantial amounts of time and effort are often required by the user to apply the locking device and then later to remove the locking device.

One solution particularly well-suited for bicycles has been to provide a cycle rack mounted to a wall. The user mounts the cycle on the rack and then utilizes a lock, such as a padlock, chain, wire lock, or u-lock, to lock the cycle to the fixed rack. These types of racks are usually relatively easily removed from the associated wall, however, such as by removing the exposed fasteners securing the rack to the wall. In addition, these types of racks typically still require the user to first mount the cycle on the rack, then mount the separate lock to the rack, lock the separate lock, and then, when desired for use or transport of the cycle, unlock the separate lock with a key or combination and perform the reverse time consuming, demounting of the lock prior to removal of the cycle from the rack.

The user may often fail to lock the cycle in the rack due to the time and effort required to lock and unlock the cycle to the rack. These, and other challenges, related to mounting, locking, unlocking of a bicycle are exemplary of safety and security concerns with other types of vehicles.

There is a need for improvement in this technical area.

### BRIEF SUMMARY

This summary is provided to introduce a selection of concepts in a simplified form that are further described below in the detailed description. This summary, and the foregoing background, is not intended to identify key aspects or essential aspects of the claims subject matter. Moreover, this summary is not intended for use as an aid in determining the scope of the claims subject matter.

One aspect of the present disclosure is directed to a vehicle parking system. The term “vehicle” as used herein is directed to any device that is used for ground transportation and includes, but is not limited to, automobiles, motorcycles, scooters, bicycles, skateboards, and other motorized as well as man-powered ground transportation devices. The parking system may include a plurality of modules or components that facilitates security, payment, surveillance, user interface, system oversight and a host of other features. Features of the present disclosure may include methods of use of and doing business with or in association with the disclosed apparatuses, or other apparatuses that may provide the process or processes of the one or more methods.

These and other aspects of the present disclosure will be apparent after consideration of the detailed description and figures herein.

### BRIEF DESCRIPTION OF THE DRAWINGS

Non-limiting and non-exhaustive embodiments of the present disclosure, including the preferred embodiment, are described as referenced to the following figures, wherein like reference numbers refer to like parts throughout the various views unless otherwise specified.

FIG. 1 is a diagram representing example features of a parking system in accordance with principles of the present disclosure.

FIG. 2 is a diagram illustrating further example physical components associated with the system shown in FIG. 1.

FIG. 3 is a schematic perspective view of an example kiosk in accordance with the principals of the present disclosure.

FIG. 4 is diagram illustrating example screen views for use with the kiosk of the present disclosure.

FIG. 5 is a schematic perspective view of an example bike rack in accordance with the principals of the present disclosure.

FIG. 6 is a schematic perspective view of an example bike parking arrangement in accordance with the principals of the present disclosure.

FIGS. 7-9 are various close-up views of the bike parking arrangement shown in FIG. 6.

### DETAILED DESCRIPTION

Embodiments are described more fully below with reference to the accompanying figures, which form a part hereof, and show, by way of illustration, specific exemplary embodiments. These embodiments are disclosed in sufficient detail to enable those skilled in the art to practice the inventions disclosed herein. However, embodiments may be implemented in many different forms and should not be construed as being limited to the embodiments set forth herein. The following detailed description is, therefore, not to be taken in a limited sense.

One aspect of the present disclosure is directed to providing electronic parking with options for various payment schemes. For example, parking may be arranged and paid for in intervals of minutes, hours, days, months and years. The system may be configured to manage parking for a transportation vehicle, such as an automobile, motorcycle, scooter, bicycle, skateboard, and other devices by monitoring use of parking spaces and ensuring payment compliance for use of such parking spaces.

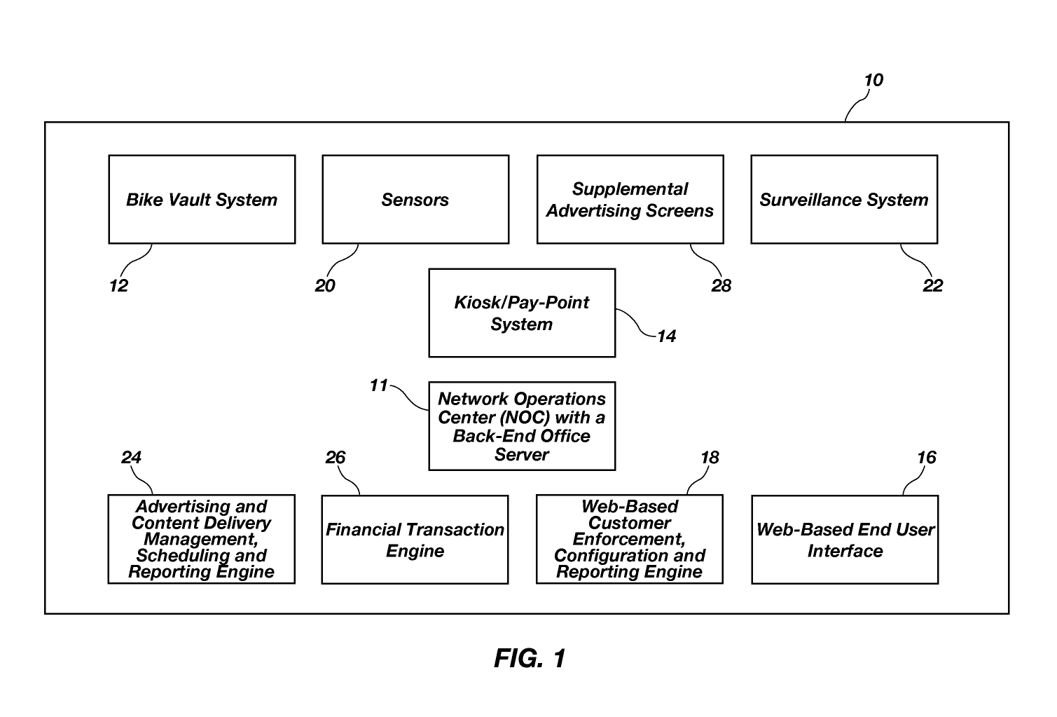

Referring to FIG. 1, an example parking system 10 is shown and described. Ten different primary components or modules are included in system 10. In alternative arrangements, fewer components may be included in the system as needed for particular end uses.

The entire system may be controlled and operated via a Back-End Office Server located in the Network Operations Center (NOC) 11. The NOC may also contain all of the requisite network controllers (e.g., firewalls and switches) to manage remotely multiple kiosks 14 in various locations. Communication between the NOC and the various kiosks can be via any type of available digital communication technology (e.g., broadband, WiFi, etc). The NOC may be operated by SST, a third party provider, or the service providing entity (e.g., a municipality). It may “physical” and it may be in “the cloud”.

One component of the system is a bike vault system 12. Some example systems for use as bike vault system 12 are included in U.S. Published Patent Application No. 2008/0094192 and Provisional Patent Application Ser. No. 61/051,617 filed May 8, 2008 and titled BLOCK APPARATUS AND METHOD OF USE, which applications are incorporated herein by reference.

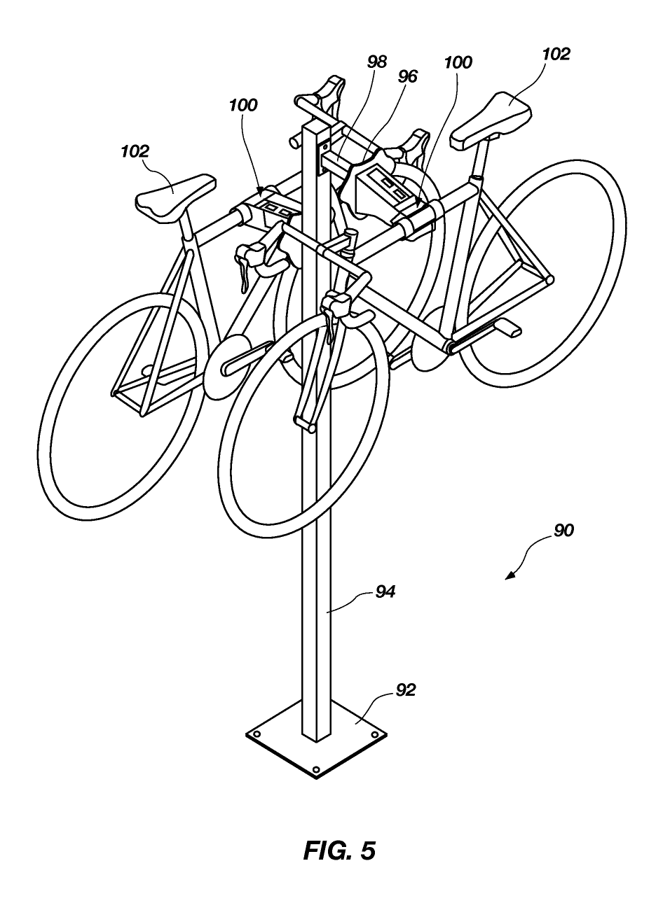

One example bike rack possible for use in the bike vault system 12 is shown and described with reference to FIG. 5. The bike rack 90 includes a base plate 92, a mounting post 94, a mounting plate 96, an extension bracket 98, and a locked apparatus 100 for mounting at least one bicycle 102. The bike rack 90 may be configured as a free-standing structure as shown in FIG. 5, or may be modified for further attachment and support by additional structures such as a building structure or adjacently positioned additional bike posts 94. Details concerning the locked apparatus 100, as well as additional embodiments and features for the bike rack 90 are provided in U.S. Published Patent Application No. 2008/00094192 and U.S. Provisional Patent Application Ser. No. 61/051,617 referenced above.

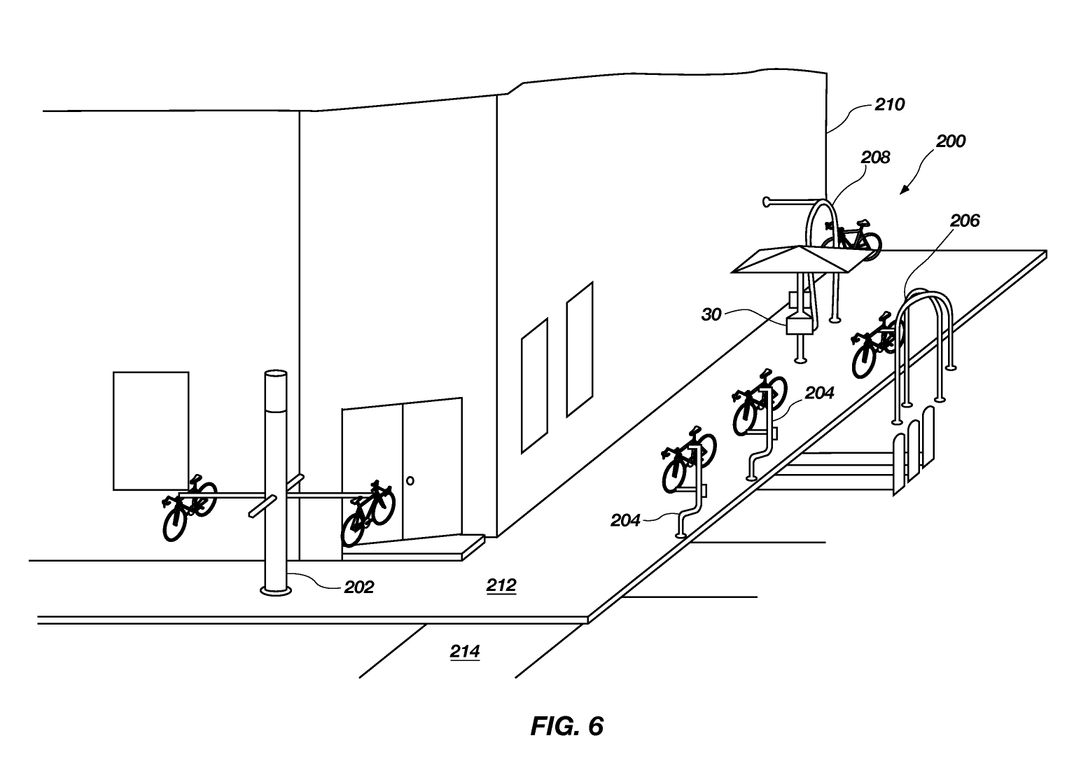

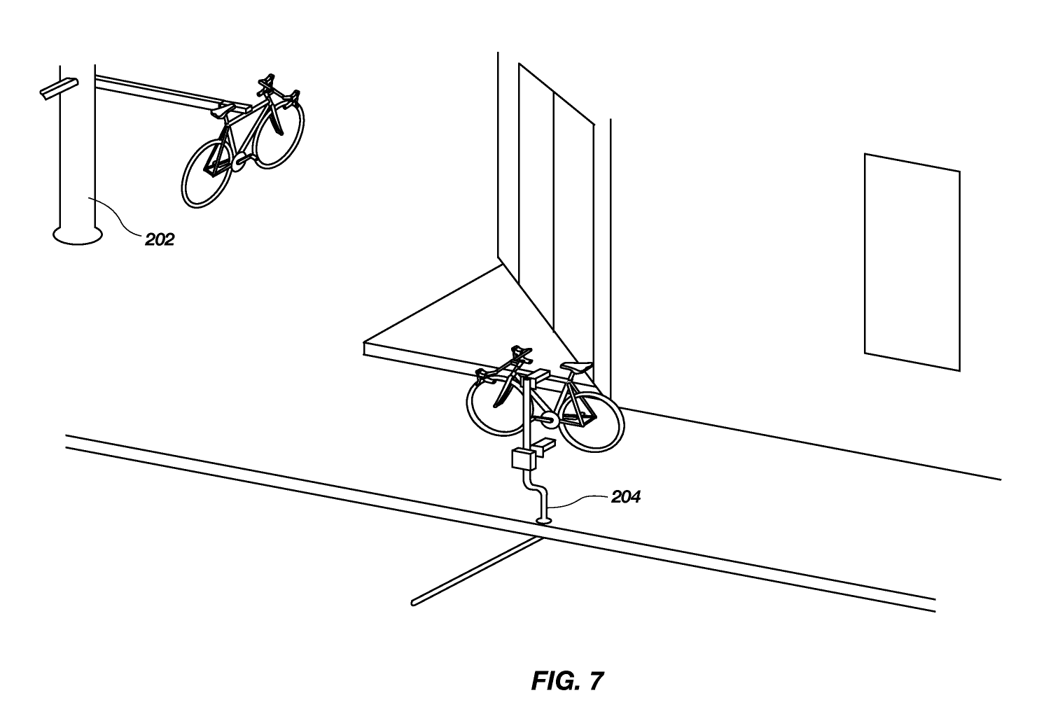

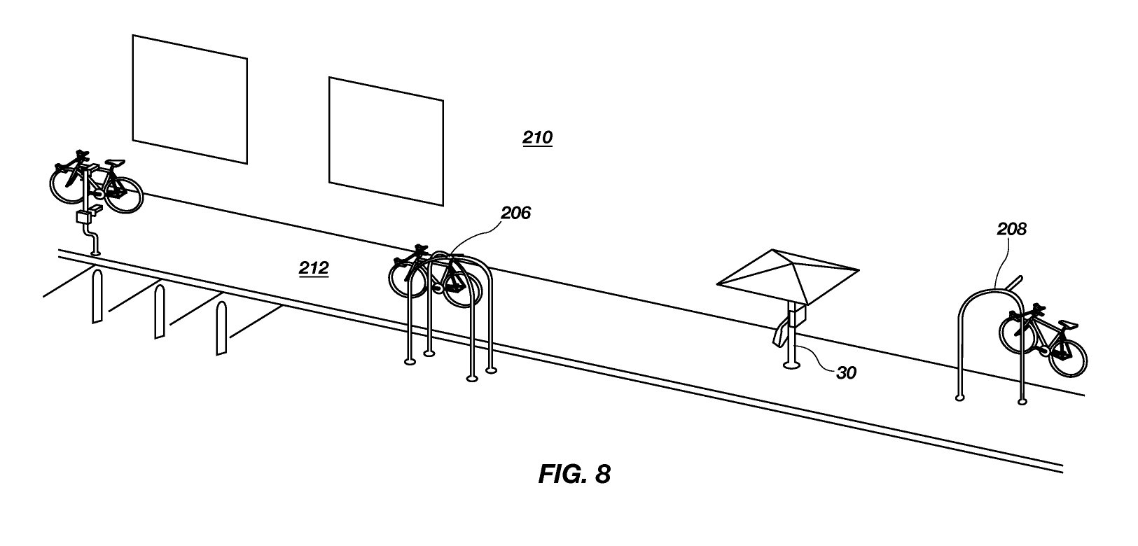

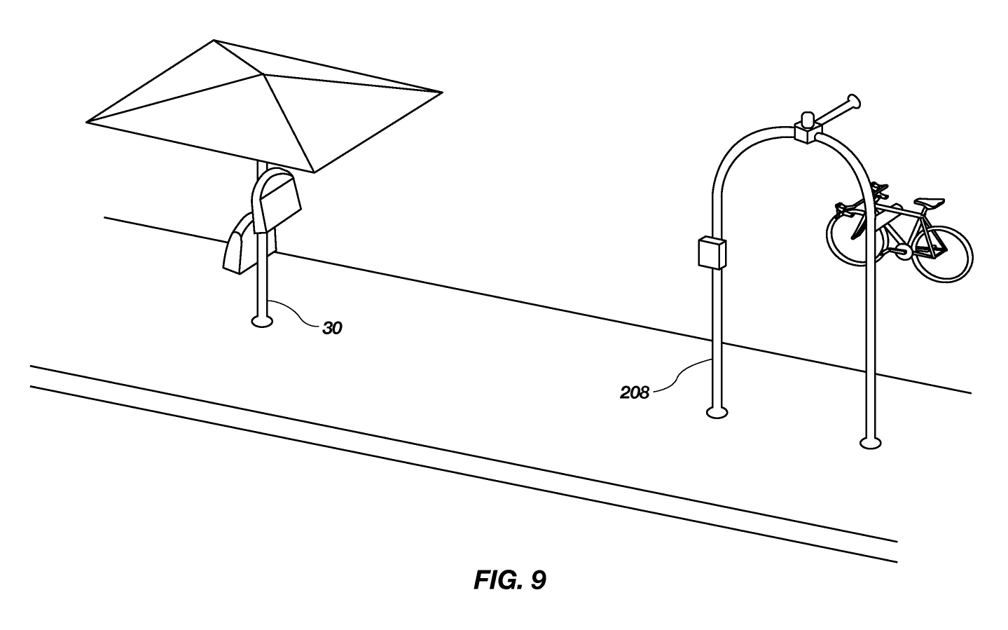

FIGS. 6-9 illustrate a bike parking arrangement 200 that includes several different bike rack constructions. The parking arrangement 200 includes first, second, third, fourth bike rack embodiments 202, 204, 206, 208, respectively. Each of the bike racks 202, 204, 206, 208 has a slightly different construction and arrangement for supporting one or more bicycles. Typically, each of the bike racks 202, 204, 206, 208 includes a locking mechanism. Each locking mechanism may be controlled at least in part by aspects of the kiosk 30, which will be described in further details below. The kiosk 30 may also provide an interface for users to make payment for use of any one of the bike racks 202, 204, 206, 208.

Some of the bike racks 202, 204, 206, 208 are positioned on a sidewalk 212, while other of the bike racks are supported or otherwise positioned on the street surface 214. Some of the bike racks are freestanding while other of the bike racks are supported at least in part by a building structure 210 or mounting posts of adjacent bike racks. The bike rack embodiments illustrated in FIGS. 6-9 are exemplary only and illustrate that many different types of bike racks are possible to implement the security and payment systems described in further detail herein.

The system 10 may further include a kiosk system 14 (also referenced as a pay point system 14). The kiosk system 14 may include a number of features and capabilities such as, for example, accepting parking payments, providing event information, providing information and links to local merchants, advertising, 911 or other police services, RFID, infrared, or other types of readers for use by, for example, frequent user passes, and user interfaces by other parties such as programmers, enforcement personnel, and the like.

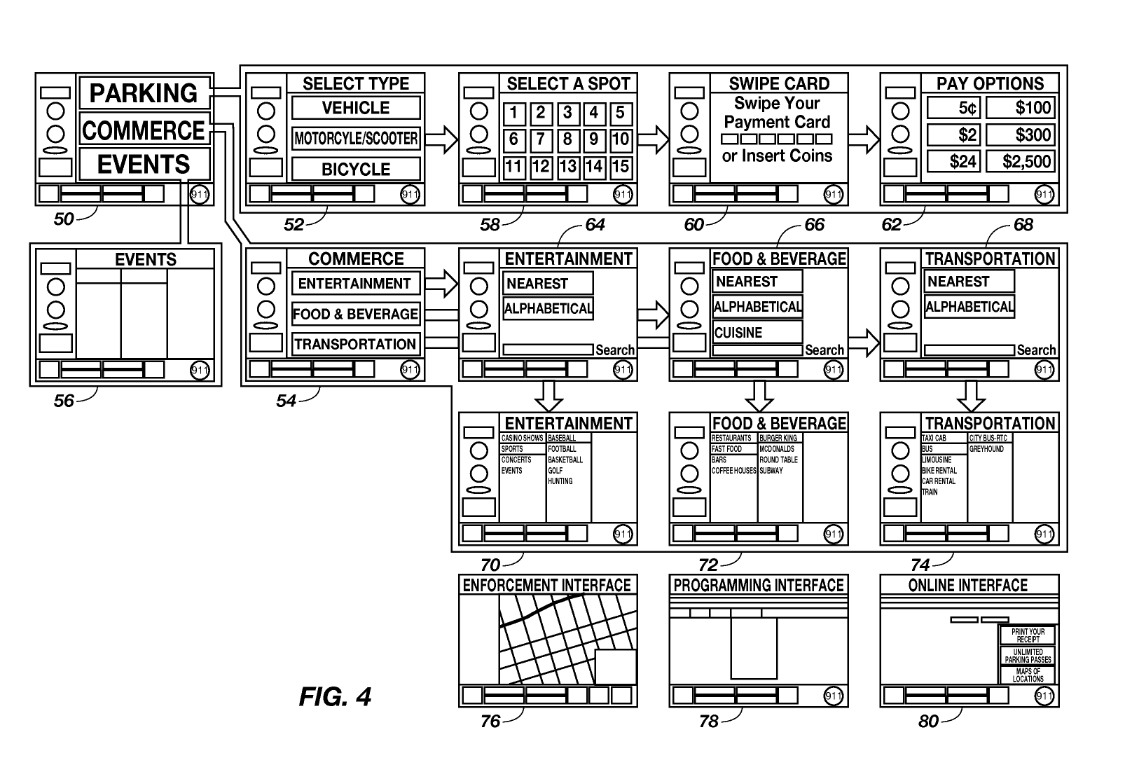

FIG. 4 illustrates a number of example screens available at the kiosk system 14. The kiosk system 14 may include a main screen 50 that provides a variety of selectable options by a user. The three primary options illustrated in FIG. 4 on main page 50 include parking, commerce and events. Other selectable portions of the screen 50 include links to: a main page 76 accessible only by enforcement personnel, a programming page 78, a link to a page 80 for an on-line interface for options, such as, for example, of printing receipts, parking passes, maps, advertisements, internet links and other options. A main page 50 may also include space available for advertisements on the screen, and links to 911 call capability.

Selection of the parking link on the main page 50 may direct the user to a parking main screen 52. The parking main screen 52 may include advertisement space and selectable options such as the main menu, enforcement, on-line programming and 911 options available on the main page 50. Further, the parking main page 52 may include selectable options for the type of vehicle being parked such as, for example, an automobile, a motorcycle/scooter, or bicycle.

Selection of one of the vehicle options may bring up a first parking auxiliary screen 58 in which the user may select the parking space in which they are parking their vehicle. The various parking spaces may be identified in any way appropriate to indicate to the user the location at which their vehicle is parked. Screen 58 illustrates in FIG. 4 parking spaces identified by number. Other identifying information such as the time at which the parking space is going to be available, how long each parking space has been occupied, the size of the parking space and similar features may be identified on screen 58.

Selection of one or more of the parking space indicators on screen 58 may take the user to a second parking auxiliary screen 60 that provides payment options selectable by the user. Some example payment options include selection of a particular type of credit card payment, payment by coin, or payment by bills. In another example, payment may be made through an on-line accessible account such as PayPal. The system may be configured to require a particular type of card for either payment of verification of account information. In another example, a biometric identification, such as a finger print scan or retina scan could be used for verification of a user's identity for purposes of payment, selection of particular parting spaces, or other functions or features associated with the parking system. The parking system may be configured to provide some type of warning or notification to either the user or the owner or manager of the parking system if the biometrics do not correlate with the requested operation, parking space, etc.

Upon selection of a payment type, an additional third parking auxiliary screen 62 may appear for viewing by the user. The screen 62 may include a variety of payment options related to the amount of time the parking space will be used. FIG. 4 illustrates the screen 62 having payment options by minute, hour, day, week, month and year.

In some arrangements, payment for the selected parking space is required prior to use of the parking space. In other arrangements, the user provides acceptance of terms and conditions of using the selected parking space at the outset of using the parking space and provides payment for use at completion of use of the parking space. In other arrangements, the vehicle is not releasable from the parking space until payment has been made. The kiosk system 14 may be coupled in electronic communication with a lock or other apparatus associated with each parking space wherein payment for parking results in release of the locking apparatus so that the vehicle may be removed from the parking space. In other arrangements, the locking apparatus is not locked until advance payment is made for parking in the selected parking space.

Selection of the commerce link on main page 50 directs the user to a commerce main screen 54. The commerce main screen 54 may include a number of selectable options, including, for example, selectable options of entertainment, food and beverage, and transportation. Other selectable options may be possible in other arrangements of the commerce main page 54. Selection of the entertainment link takes the user to a first commerce auxiliary screen 64 related to entertainment. Various options are available to the user, such as, for example, searching for entertainment based on relative location, or by alphabetical listing. Other search options may be provided such as, for example, certain categories of entertainment, e.g., music, theater, sports, etc. on the screen 64. Further screens associated with screen 64 may include an entertainment auxiliary screen 70 that includes main and subcategory options for selection by the user.

Selection of the food and beverage link on the commerce main screen 54 may provide a second commerce auxiliary screen 66 for viewing by the user. Various options may be provided for selection by the user including, searching by location, alphabetical listing, or cuisine. Additional screens may be provided such as a food and beverage auxiliary screen 72 that lists types of food options such as fast food, bars, coffee houses, deli's with sub categories of particular restaurants within each of those categories and details concerning items listed in the subcategories.

Selection of the transportation option on the commerce main screen 54 provides a third commerce auxiliary screen 68 for viewing by the user. Again, options may be provided to the user on screen 68 based on location, alphabetical listing, and other categories. A selection of options on the auxiliary screen 68 may provide additional screens such as the transportation auxiliary screen 74 shown in FIG. 4. The auxiliary screen 74 provides a list of categories of transportation with subcategories and detailed information concerning each of the listed subcategory items available for viewing by the user. Many other screen options including various additional categories are possible on the subject of commerce available at the main screen 50.

Selection of the events option on the main screen 50 may take the user to an events main screen 56. The events main screen 56 may include information about local events available based on dates and relative location. A list of events may be categorized by various subjects. Further, the events may be searched using, for example, a list of upcoming events or a calendar option such as a month in one view calendar option. Various auxiliary screens related to events are possible for selection by the user on the main events screen 56.

Any one of the screens described with reference to FIG. 4 may include a common layout with a consistent location provided for advertisement in other areas of the screen with reoccurring selectable links (i.e., main menu, enforcement, on-line, pay point, programming, 911) and separate space for variable selectable options (i.e., parking, commerce, events).

The inclusion of commerce and events subject matter on the main screen 50 may make the kiosk system 14 useful for people in addition to those selecting and/or paying for a parking space. The kiosk system 14 may be located, for example, in a pedestrian accessible area, such as on a sidewalk 212 as shown for the kiosk 30 in FIG. 6. The kiosk system may be a source of information as well as a centralized parking payment and management system.

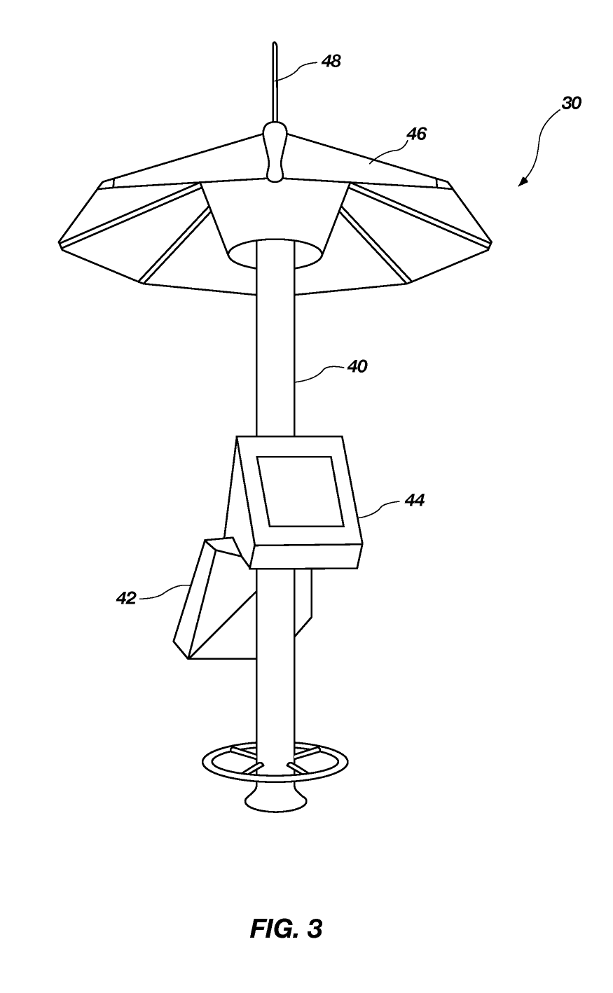

FIG. 3 illustrates an example kiosk 30 having a base 40, a user interface screen 42, an advertising screen 44, a canopy 46 and a communications member 48. The base 40 may be a free-standing structure or may be arranged to be supported by additional structures such as a building, a bike rack system 12 or other structure. Capabilities of the user interface screen 42 have been described above related to FIG. 4. Details concerning the advertising screen 44 are provided below related to the description of the supplemental advertising screen 28 shown in FIG. 1. The canopy 46 may be any structure functioning to provide some protection from the elements for the screens 42, 44 and users interfacing with those screens. In some embodiments, heating or cooling structures may be associated with the canopy 46 to provide heat and/or cooling to the users in proximity to the kiosk 30. The communications member 48 may provide wireless communication with communications such as the internet, cellular and satellite systems. Alternatively, the kiosk 30 may have a hard wire communication with remote systems via, for example, cabling, telephone or other wired systems.

At least the user interface screen 42 may include, for example, an infrared hardened outdoor screen, a standard computer, an operating system, and customized software to provide the desired operability and functionality. The kiosk system 14 may be provided with security tools that prevent hacking into the operating system and software of the kiosk system 14.

The system 10 may further include a web-based end user interface 16 supported by the NOC 11. The interface 16 may provide remote access to, for example, receipts, parking payment and history, as well as for remote operators to purchase subscriptions to services related to parking. Custom software may be associated with the interface 16 then may provide the interface using a variety of languages.

The system 10 may include a web-based customer enforcement, configuration and reporting engine or module 18 supported by the NOC 11. The module 18 may be accessible through, for example, a website with secure access to back office data. The engines 18 may include the ability for a customer to dynamically configure rates and time limits (e.g., varying rates depending on the type of event in proximity to the parking spaces), receive notification of violations, 911 calls, and comprehensive reporting capabilities. In some cases, the customer is a municipality, school of advanced learning (e.g., a university) or events manager (e.g., a convention center or professional sports facility). The engines 18 may provide such customers with closely monitored and modified information associated with individual kiosks systems 14.

The system 10 may include a plurality of sensors 20. One set of sensors may be in accordance with the locking mechanism disclosed in detail in U.S. Published Patent Application No. 2008/0094192 and Provisional Patent Application Ser. No. 61/051,617. Other sensors may include mass detection sensors embedded in the parking support structures (i.e., parking lot lanes) to detect the presence of automobiles, motorcycles, scooters, bicycles, etc. Such mass detection sensors may include, for example, a copper wire embedded slightly below the surface of the support structure that may detect the presence of a vehicle.

Additional sensors may include an infrared or other sensor that detects motion, or the presence of an object when the object leaves and departs. Such positioning sensors may also be used, for example, in a motorcycle parking space to secure the space. The parking space may include, for example, a simple pole (i.e., a bollard) that houses an electrified and alarmed cable that encircles the wheels, frame, or combination of features of the vehicle.

Other example sensors include an RFID sensor that may be for example, low-powered in the kiosk so that the user simply walks by the system, or a high-powered system similar to a fast track payment system that allows the user to park where information is automatically recorded by the system.

Another example of sensors may include cameras that collect video or still shot images of the parking spaces, kiosk, and other aspects of the system 10. These cameras may also include license plate cameras that monitor license plate information that may create, for example, an optical character recognition (OCR) readable picture of a vehicle positioned in a parking space. Such license plate information may be used to determine parking presence.

The system 10 may include a surveillance system 22 that is used to monitor the vehicles and use of various aspects of the system such as the kiosk system 14 and any parking spaces. The surveillance system may include, for example, cameras that collect video or still shot images of the parking spaces, kiosk, and other aspects of the system 10. A surveillance system may also include license plate cameras that monitor license plate information that may create, for example, an optical character recognition (OCR) readable picture of a vehicle positioned in a parking space. Such license plate information may be used to do auto lookup of, for example, expired plates, uninsured plate vehicles, and owners or drivers of the vehicles that are wanted for other reasons. Aspects of the surveillance system may also be positioned at the kiosk to monitor public accessing the kiosk or those that are in or around location of the parking spaces.

Notification systems may be associated with the surveillance system or may operate independently. Such notification systems may provide notification to customers via, for example, telephone or email notices, to enforcement personnel related to, for example, unpaid overtime violators, criminal activity, or by providing a warning signal, either audibly or visually at the location of the parking spaces. Such notification may be in the form of an alarm for various types of tampering or possible damage to the vehicle. Such alarms may be contained within the kiosk, locking apparatuses associated with the parking spaces, or be provided by separate alarm systems such as a building alarm system adjacent to the parking spaces.

The system 10 may further include advertising and content delivery, management, scheduling and reporting engines for module 24. The module 24 may be used to create reports, provide scheduling information, effect change of advertising and other content information at the kiosk or at other locations.

System 10 may include a financial transaction engine or module 26. The module 26 may provide the ability, for example, to collect payments, deliver subscription based services, allocate commissions, permit local businesses to validate parking spaces in use, and other financial related functionality.

System 10 may include a supplemental advertising screen 28 for use at a kiosk in addition to the kiosk screen 42 shown in FIG. 3. The supplemental screens 28 are represented by the screen 44 shown in FIG. 3 and may provide additional advertising capability in association with the kiosk screen 42. In some arrangements, the kiosk 30 may include multiple kiosk screens 42 or multiple advertising screens 44.

Another function of system 10 may include vehicle rentals, such as the rental of bicycles. The system 10 may include at least one bike vault system 12 that retains at least one rental bicycle. The main screen 50 of the kiosk system 14 may include a selectable option for vehicle rentals that takes the user to a vehicle rental screen. The vehicle rental screen may include a plurality of selectable options such as, for example, renting a vehicle, returning a vehicle, and storage or parking of a rented vehicle.

Selection of at least some of the selectable options on the vehicle rental screen may require payment via the financial transaction system 26. Payment may be made using, for example, credit card, student identification card, vehicle parking card, bus pass, and online payment account. Payment may be made for various time increments, such as, for example, minutes, hours, days, etc. The rented vehicle may be returned or temporarily stored by, for example, first swiping a card or providing other user identification information. In some arrangements, other aspects of the system 10 are tied to completion of payment. For example, the bike vault system 12 may be configured to not release the rented vehicle for use until payment is made. In another example, the system 10 may withhold a rental deposit that has been retained (e.g., via the user's credit card, parking card, or student identification card) until the vehicle has been safely returned to the bike vault system 12.

The system 10 may also be configured to provide notification of empty parking spaces to end users. In one example, potential end users may sign up to receive notification of empty parking spaces. Such notifications may be pushed to end users from the system 10 using, for example, smart phone or email notifications.

The system 10 may be particularly useful for monitoring parking activity near sensitive areas such as, for example, banks, government buildings, and events locations. The system 10 may be configured to monitor how long a vehicle has been parked, the make, model and year of the vehicle, the frequency of a particular user in a given parking space or zone of parking spaces, and other aspects related to parking trends or behavior that may be useful. The information gathered by system 10, such as user information and parking trends may be helpful in the event something inappropriate occurs in the area of the parking space and information about the user of the parking spaces and/or kiosk is relevant.

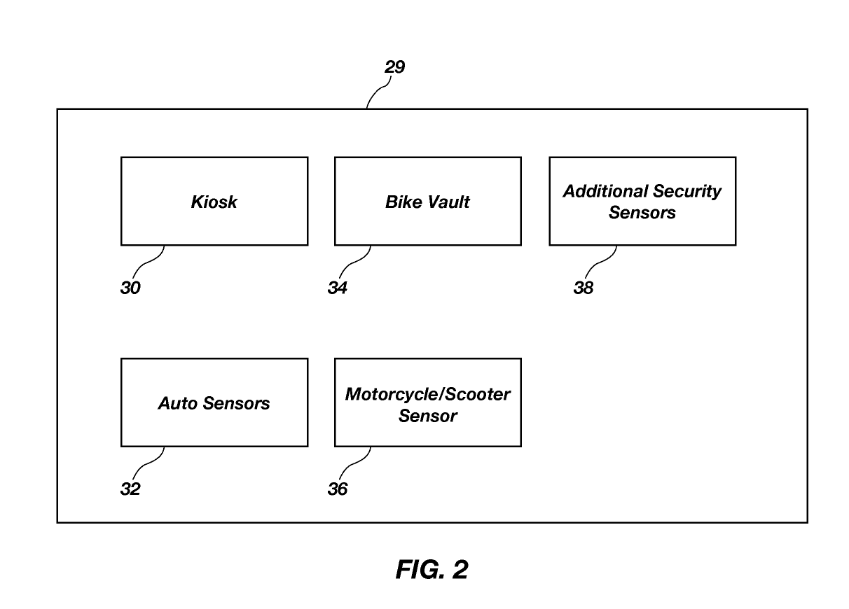

There are several components of the system 10 in which additional information concerning the manufacture and assembly may benefit from additional detail. FIG. 2 includes a grouping 29 of such components including, for example, the kiosk 30, autosensor 32, bike vault 34, motorcycle/scooter sensor 36 and additional security sensors 38.

The kiosk 30 may be assembled from standard computer hardware and software with the addition of, for example, a Lexan screen and infrared sensors for touch screen capabilities. The computer, electrical distribution, dated distribution and other functionality are contained in the kiosk in a, for example, vandal resistant and waterproof manner. The kiosk may have a canopy or umbrella 46 as described with reference to FIG. 3 to provide shade and protection from the elements. The umbrella or canopy portion 46 may also include lighting as well as structure for mounting cameras, wireless radios and other communication features such as the member 48. The kiosk may also include speakers and other features to meet ADA (American Disability Act) Compliance.

The autosensors 32 may be connected to the kiosk via a wireless connection. The autosensor may be a simple capacity sensor that senses mass location. Similar sensors may be used for motorcycles, scooters, bicycles and other vehicles to indicate proximity of the vehicle at a parking space. To install a capacity sensor, a simple groove may be cut in the asphalt and the sensor is laid in the groove and coated with, for example, an epoxy sealant.

Aspects of an example bike vault or bike rack 34 is described in greater detail in U.S. Published Patent Application No. 2008/0094192 and U.S. Provisional Ser. No. 61/051,617, which are incorporated herein by reference.

The motorcycle/scooter sensor 36 may be built and include a bollard with the capacity of IR, or other electronic sensors that sense that the vehicle has been placed between the bollards. The sensor may also include a system similar to the autosensor described above in place of, or in combination with the motorcycle sensor. In the case of using bollards, the system may utilize an electrified and alarmed cable to secure the motorcycle/scooter from theft. The bollards may be connected to the kiosk via a wireless or wired connection.

The additional security sensors may include the license plate camera described above to collect information concerning the license plate of the vehicle, or collect information from license plates on vehicles passing by the camera. The camera may be connected to a network based OCR reader that converts the image of the plate to a machine readable character that may then be matched with various law enforcement data bases, including, for example, stolen vehicles, outstanding warrants, uninsured vehicles, etc.

The system 10 described above may be used by a variety of potential end users such as, for example, the general public, enforcement personnel, city administrative staff, downtown business merchants and others in the area of close proximity to the parking spaces.

As to use by the general public, the public may use the system when parking a vehicle, or use the system as a pedestrian in the area of the parking spaces. To use the system, the user approaches the kiosk and selects from options for parking, shopping or dining (i.e., commerce) or events as described above with reference to FIG. 4. In the event the user selects parking, the user may select what type of vehicle they are parking, the rate plan (i.e., minute, hour, day, week, etc.), and the payment method (i.e., credit card, cash or coin). For those shopping or dining, the user may search by proximity, cuisine, type of entertainment or transportation. The user may have the option of making reservations or partaking in promotions, among other options available under the commerce option that is described above with reference to FIG. 4.

For the events users, the user may search by day, proximity, and other options to purchase tickets, make reservations and partake in promotions provided by, for example, merchants and venue managers.

As to enforcement personnel, the system 10 provides a mobile interface for enforcement personnel. The system may notify the violations (i.e., non-payment, overtime payment, 911 calls, illegal parking, etc.) by a variety of data formats. The enforcement screen at the kiosk may also permit printing of tickets, work orders, and look up of license plate for outstanding tickets, warrants, and the like. At least some remote enforcement interfaces may be integrated into the system 10 via, for example, capabilities of the NOC 11.

Use by administrative staff permits for dynamic changes to most all variables of the system, including, for example, pricing (i.e., zone, rate, time, etc.), updates, advertising, etc. Administrative staff may access the system via a secure internet or intranet login and access variables via a standard Windows style pull-down menu system. The system 10 may be protected using standard data security measures including, for example, encryption.

Merchant use of the system 10 permits for merchants to advertise, validate on street or other type of parking, and accept reservations among other functionality. The system 10 may be accessed by merchants, via either an integrated POS system provided by SST or a web browser, among other communications options. Merchants may use the same credit card that consumers use for merchandizing to validate and pay for parking, allowing the user to enjoy free on the street parking provided by the merchant. The system 10 may provide a merchant with the option of pre-purchasing blocks of parking from, for example, the city, providing the city with prepayment and more efficient use of parking spaces available.

Many types of communication systems are available including, for example, WiFi, mesh radio, internet, intranet, cellular, satellite, and other types of communications for system 10. Information may be reported in standard and customized formats on all different types of data collected. The system 10 may be provided with a connection to a call center or other customer service link for user financial and technical assistance. System 10 may also provide on-line access to parking history and receipts allowing the system to be paperless if desired.

It can thus be seen that the embodiments described above may provide many advantages such as for example and without limitation:
A plurality of payment schemes based on time intervals (i.e., minutes, hours, days, months, years).
A centralized parking management system for parking of any type of vehicle (e.g., automobile, motorcycle, scooter, bicycle, skateboard, etc.).
A user interface operable through a kiosk that accesses a parking management system for payment of vehicle parking services.
A kiosk that defines a user interface for payment of vehicle parking services that additionally provides commerce and events information to a user.
Remote access and monitoring of a parking system through the Internet.
Offsite security and monitoring of parked vehicles.
Monitoring and controlling vehicle (such as for example bicycle) rental and rental payment electronically and, in some embodiments, from a remote location, in some embodiments with need for less and possibly no human interaction with the renter at the rental or bicycle return location(s).

Although the system 10 and other aspects of the present disclosure have been described in language that is specific to certain structures, materials and methodological steps, it is to be understood that the invention is not limited to these specific structures, materials and/or steps described. Unless otherwise indicated, all numbers or expressions, such as those expressing dimensions, physical characteristics, etc. used in the specification are understood as modified in all instances by the term “approximately” at the very least, and not as an attempt to limit the application of the doctrine of equivalence to the claims, each numerical parameter recited in the specification or claims which is modified by the term “approximately” or “substantially” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1-10 should be considered to include and provide support for claims that recite all and any subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.994, and so forth).

What is claimed is:

1. A vehicle parking system, comprising:
a bicycle locking assembly operable to store a parked bicycle;
at least one automobile sensor operable to determine presence of a parked automobile;
at least one motorcycle sensor operable to determine presence of a parked motorcycle;
a kiosk comprising a user interface, wherein a user inputs information into the kiosk at the user interface concerning parking of at least one of a bicycle, an automobile, and a motorcycle.

2. The vehicle parking system of claim 1, further comprising a control system comprising:
means for providing vehicle parking and/or security;
means for receiving payment for parking and/or use of a vehicle;
means for surveilling the vehicle security area; and
a system oversight module.
